(19) United States
(12) Patent Application Publication
(10) Pub. No.: US 2006/0253690 A1
(43) Pub. Date: Nov. 9, 2006

(54) Bulk preload and poststore technique system and method applied on a unified advanced VLIW (very long instruction word) DSP (digital signal processor)

(76) Inventors: Tien-Fu Chen, Chia-Yi (TW); Chun-Li Wei, Chia-Yi (TW)

Correspondence Address: SCHMEISER, OLSEN & WATTS, 22 CENTURY HILL DRIVE, SUITE 302, LATHAM, NY, 12110, US

(21) Appl. No.: 11/121,555

(22) Filed: May 4, 2005

(51) Int. Cl. G06F 9/44

(52) U.S. Cl. 712/241

(57) ABSTRACT

The present invention is a bulk preload and poststore technique system and method applied on a unified advanced VLIW (Very Long Instruction Word) DSP (Digital Signal Processor), specifically the system and method for exchanging data between register files that works in a VLIW architecture. The method of the present invention comprises: an iteration of the prolog; an iteration of the loop body; and an iteration of the epilog. The system of the present invention comprises: a bulk memory access controller; a buffer register file; a switching module; and a registered file switch controller.

### BACKGROUND OF THE INVENTION

1. Field of the Invention

The present invention is a technique system and method with bulk preload and poststore applied on a unified advanced VLIW (Very Long Instruction Word) DSP (Digital Signal Processor), specifically a system and method for exchanging data between register files that works in a VLIW architecture.

2. Description of the Prior Art

Newer fabrication technology brings better performance improvement. While a large advance on performance is made by processor, the counterpart access speed of main memory is improved slowly. The gap of performance between processor and main memory causes processor to idle while memory access. As the gap of performance is getting larger, the processor idle time, which is caapplied by memory access operation, becomes longer. As a result, executions of function units stop and wait for the memory access. Hence, utilization of function unit in a processor is decreased and the overall system performance is thus decreased. Utilization problem is getting worse if the amount of function unit is getting larger.

VLIW architecture has been well developed to satisfy the performance requirement of multimedia applications. Although a lot of function units are provided by VLIW architecture to increase instruction level parallelism (ILP), however, due to the memory access operations, most of the VLIW architecture suffers from low function-unit utilization. Memory access latency always causes a processor to stall for a long time and function units should be stopped and wait for the memory access to be finished. This problem is getting worse while the amount of function-units becomes larger.

Numerous function units are incorporated in the VLIW architecture. Thus, the requirement of register file ports is large. Centralized register file connects all the read ports and the write ports with all function units. Clustered register file only connects the read ports and the write ports with local function-units. Thus, the port requirement of clustered register file is smaller than the centralized register file. Consequently, the circuit design, the area, the power consumption and the operation clock rate of clustered register file is easier, smaller, smaller and faster.

Clustered method can separate function units into several groups and each group has its own local register file. However, data communication between clusters is a big problem. Data communication can be done by equipping cross path or load/store operations. Using load/store operation will be time consuming and each cluster should be equipped with a load/store unit. If the amount of cluster increases, the load/store operations will increase dramatically due to inter-cluster communication. Equipping cross path requires additional read write ports for each clustered register file. If the amount of cluster increases, the additional read write ports will make the design of register file more complex and the access latency of the register file will slow down the clock rate of processor.

Shadow register file system provides an additional copy of register sets. Processor can preload the content of next process into shadow register set and context switch is accomplished by switching primary register sets with shadow register sets. Switching of register file can transfer a block of data at once.

The non-blocking memory access operations can be performed earlier enough before switching register sets. Therefore, the content of next process can be ready before context switching. Consequently, the delays of storing and loading of register set can be reduced.

The non-blocking memory access operations are worked without stopping pipeline even if memory data is not ready. Therefore, the other operations can be kept on execution without waiting for the memory access. However, the following loads and stores should be blocked to guarantee correctness.

Delays of context switching can be efficiently reduced by register shadowing and switching in the multi-tasking system. An efficient data transfer mechanism will be desirable to accelerate inter-cluster communication and to increase function unit utilization on clustered architectures.

### SUMMARY OF THE INVENTION

The present invention is a bulk preload and poststore technique method applied on a unified advanced VLIW (Very Long Instruction Word) DSP (Digital Signal Processor), providing a cluster-type of very long instruction words (VLIW), consisting of multiple clusters, and carrying out switching of single-cycle register file. In this technique, a bulk memory access controller (BMAC) fully utilizes memory bandwidth and efficiently accesses data memory by exploiting DSP addressing modes. A register file switch module (RFSM) logically exchanges the contents between two register files to achieve fast data movement. A register file switch controller (RFSC) controls RFSM without interrupting pipeline propagation.

The present invention is a bulk preload and poststore technique system applied on a unified advanced VLIW DSP, providing a bulk memory access controller (BMAC) that performs block-based memory access. The BMAC controller can fully utilize memory bandwidth in superior priority, and it loads or stores a set of data by one preload or poststore instruction. The BMAC controller can be either invoked by dedicated instruction slot or other function units.

The present invention is a bulk preload and poststore technique system applied on a unified advanced VLIW DSP, providing an additional register file that has the same number of read ports, write ports and registers compared to the register files of the other clusters. So that, the requirement of read write ports of the other cluster will not be limited by this register file after switching.

The present invention is a bulk preload and poststore technique system applied on a unified advanced VLIW DSP, providing a register file switch module (RFSM) that connects register files with clusters to form a switch network. Initially, each cluster in the switch network is assigned a default register file. The RFSM switches two register files by switching the register read write directions of two clusters such that the contents of the two register file can be transferred in one cycle.

The present invention is a bulk preload and poststore technique system applied on a unified advanced VLIW DSP, providing a register file switch controller (RFSC) that controls the register file switch module. The RFSC can be either invoked by dedicated instruction slot or other function units. The RFSC sends out control signals to the register switch module which determines the access directions of the clusters.

The present invention is a bulk preload and poststore technique system applied on a unified advanced VLIW DSP, providing a register files switching system in VLIW architecture. The register files switching system comprises the bulk memory access controller (BMAC), the additional register file for BMAC cluster, the register file switch module (RFSM) and the register file switch controller (RFSC). The BMAC and the additional register file are coupled as an additional cluster that transfers data between the register file and memory. The BMAC is responsible for detecting data hazards and avoiding out-of-order execution. The RFSM connects clusters to form a switch network. After the bulk memory access operation is done, the RFSC can switch the loaded data with the data that is going to be stored between clusters in the switch network. The RFSC can also switch contents between arbitrary clusters to transfer a block of data in one cycle.

To facilitate understanding the purpose of the present invention and its characteristics and effects, a specific embodiment of the present invention is described in detail as follows.

### BRIEF DESCRIPTION OF THE DRAWINGS

FIG. 1 is a block diagram of a simple processor system of the present invention;

FIG. 2 illustrates a preferred embodiment of the present invention;

FIG. 3 is a block diagram of a bulk preload and poststore technique system of the present invention applied on a unified advanced VLIW (Very Long Instruction Word) DSP (Digital Signal Processor DSP);

FIG. 4 is a block diagram of a preferred embodiment of a bulk preload and poststore technique of the present invention applied on a unified advanced VLIW (Very Long Instruction Word) DSP (Digital Signal Processor DSP);

FIG. 5 is a block diagram of a preferred embodiment of a code sequence according the present invention.

### DETAILED DESCRIPTION OF THE INVENTION

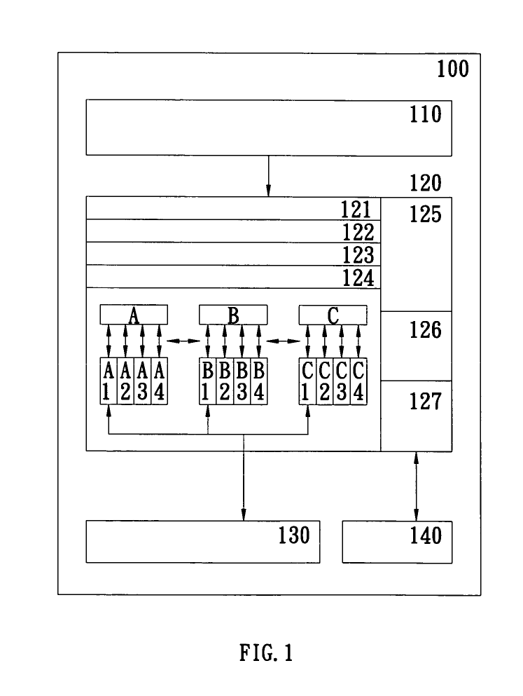

FIG. 1 is a block diagram that describes a simple processor system. A simple processor system (100) comprises a program memory (110), a processor core (120), a data memory (130) and I/O peripherals (140). The program memory (110) stores instructions of applications for processor to execute. The data memory (130) stores operands according to the instructions. The processor core (120) fetches instructions from program memory and loads operands from data memory for execution. This clustered VLIW processor core (120) comprises a program fetch unit (121), an instruction dispatcher (122), an instruction decoder (123), executed data path (124), system registers (125), control logic (126) and interrupt interface (127).

In FIG.1, the data path (124) of the VLIW core (120) is partitioned into cluster A, cluster B, and cluster C. Each cluster comprises one register file and four function units as A1, A2, A3, A4, B1, B2, B3, B4, C1, C2, C3, C4. The function units of each cluster read operands from its local register file and write results to its local register file. Data, which is stored in register file A and is to be applied by, should be copied to register file B in advance through reserved read write ports of the register file before using by the function unit of cluster B. The reserved read write ports and the connections, which are applied for data transfer between register files, are called cross path. The cross path can only transfer one data a cycle. If data transfer across cross path happens frequently, the cross path will not be adequate to transfer a burst of data.

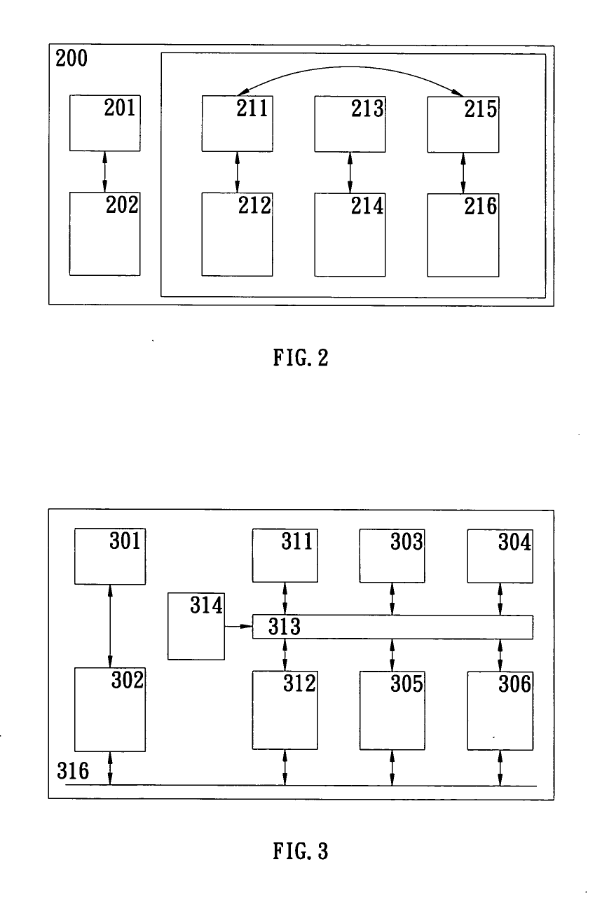

FIG. 2 illustrates a preferred embodiment of the present invention. In FIG. 2, a register file switch system (200) is shown, wherein a register file (201) is coupled to a cluster (202), a buffer register file coupled to a bulk memory access controller (211), a register file (213) is coupled to a cluster 214, and a register file (215) is coupled to a cluster (216). The key point is to exchange the contents of two register files in one cycle. Furthermore, the register files (211,213,215) in the switch network (210) can be switched arbitrarily by program control.

FIG. 3 is a block diagram of a bulk preload and poststore technique system of the present invention applied on a unified advanced VLIW (Very Long Instruction Word) DSP (Digital Signal Processor DSP). The bulk preload and poststore technique system is equipped with four modules. These four additional modules are buffer register file (311), bulk memory access controller (312), register file switch module (313) and register file switch controller (314). The four units mentioned above are connected to form a switch network. The buffer register file (311), connecting with register file switch module (313), is a temporal register file to keep the switched data, and other register files (301), (303), and (304) connect with clusters (302), (305), and (306). The bulk memory access controller (312) stores the switched data to data memory and loads the newer data from data memory. The register file switch module (313) switches the register files in the switch network. The register file switch controller (314) controls the register file switch module (313).

The buffer register file is the same as any other register file in the switch network. The amount of read write ports of the buffer register file should be the same as the other register files. Therefore, the same read/write operations can be supplied by the switched register file as the former register file at any time instant. The amount of registers in the buffer register file should be the same as the other register files, too. Such that, these register files are applied the same in the switch network.

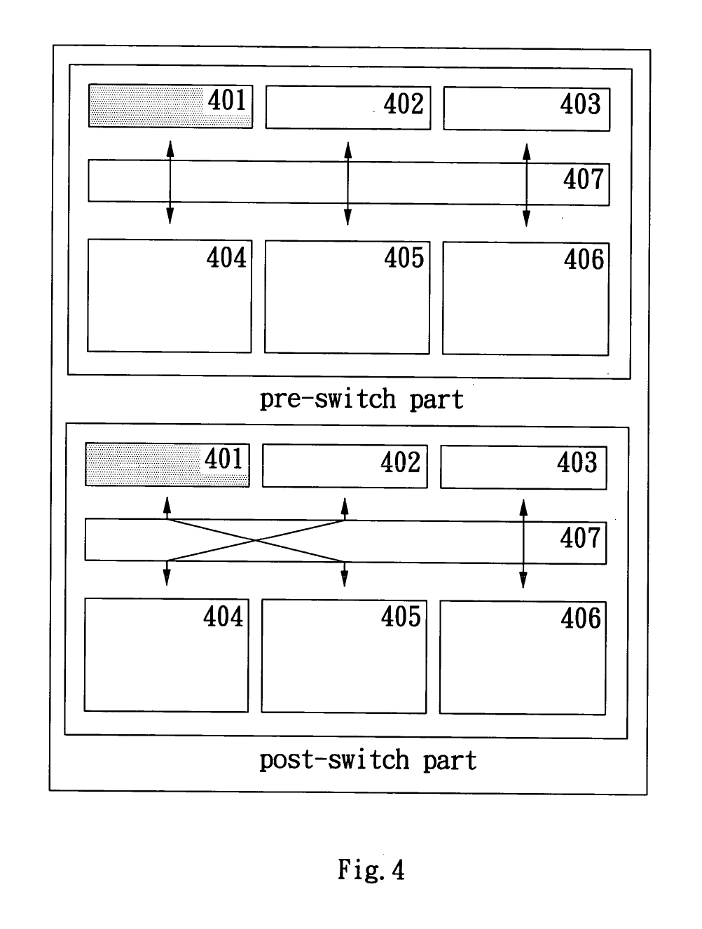

The register file switch module (313) logically switches the contents between two register files. Actually, the register file switch module (313) just switches the target register files of two clusters. Putting it accurately, the register file switch module, by conducting all read/write operations to substituting register files, can switch target register files of two clusters without having to actually switch data between two register files. Take FIG. 4 as example that shows a block diagram of a preferred embodiment of switching register files, wherein three register files are buffer register file (401), register file (402), and register file (403), respectively. Initially, as shown as a pre-switch part (a) in FIG. 4, a buffer register file (401) is applied by the bulk memory access controller (404), register file (402) is applied by cluster (405) and cluster (406) uses register file 3 (403). The whole contents are being switched between the buffer register file (401) and the register file (402). Therefore, as shown as a post-switch part (b) in FIG. 4, the register file switch module (407) switches the target register file (401) of the bulk memory access controller (404) to register file (402), and switches the target register file (402) of cluster (405) to buffer register file (401). Finally, register file (402) becomes the target register file of the bulk memory access controller (404) and the buffer register file (401) becomes the target register file of cluster (405). Consequently, the contents between two register files (401,402) are just switched logically in one cycle. Data is not really transferred between two register files, but only the read/write ports of two register files are switched.

As further shown in FIG. 3, the register file switch controller (314) is designed to control the register file switch module (313). The register file switch controller (314) records the target register file of each cluster in the switch network and sends out control signals to control the register file switch module (313). The register file switch controller (314) maintains states for each cluster. These states determine the target register file of each cluster, and each value of these states always differs from the other. The register file switch controller (314) simply interchanges the values between two states so that the target register files of the influenced clusters change. The register file switch controller can be invoked by dedicated instruction slot or control signals from the other function units.

The bulk memory access controller (312) loads data from memory to buffer register file (311) and stores data from buffer register file (311) to memory. The bulk memory access controller (312) works like a helper thread which helps handling memory access. After the bulk memory access controller (312) is invoked, the bandwidth of data buses can be fully applied. The bulk memory access controller (312) accesses data memory in non-blocking fashion so that function units can keep on register operations without waiting for the memory access operation to be finished. However, any load/store operation should be blocked before the bulk memory access finishes. The bulk memory access operation may work for a long time. However, user program does not know when the bulk memory access controller (312) will finish its task. Therefore, problems of the synchronization of data dependency occur if user wants to use the data right after the bulk memory access operation during the bulk memory access controller (312) is working. These problems happen at runtime, so a finite state machine is maintained in both processor core and the bulk memory access controller (312) to handle these problems.

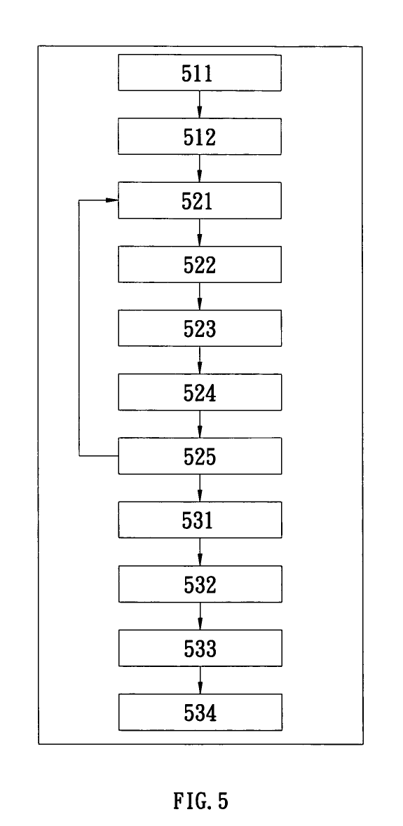

The proposed apparatus can massively contribute to performance with appropriate code generation method. FIG. 5 illustrates a block diagram of the code sequence of a preferred embodiment of the present invention. The block diagram in FIG. 5 is a bulk preload and poststore technique of the present invention applied on a unified advanced VLIW (Very Long Instruction Word) DSP (Digital Signal Processor DSP), comprising the following steps:

Step (511): preloading data into a buffer register file in a second iteration by way of bulk memory access operation in a prolog;

Step (512): continuing a first iteration, this being facilitated by using non-blocking bulk memory access operation;

Step (521): completing the first iteration and starting a second iteration in a loop body, therefore, exchanging preloaded data of the second iteration with the executed data of the previous iteration

Step (522): the previous executed data in step (521) being stored in terms of postsotring operation;

Step (523): carrying out a first half operation of the iteration;

Step (524): preloading the poststored executed data in the step (522) for next operation;

Step (525): recurring to step (521) and carrying out a second half operation of the iteration, continuing this sequence until a second last iteration;

Step (531): exchanging last executed data of the second last iteration;

Step (532): storing the executed data of the second last iteration;

Step (533): carrying out a last iteration; and

Step (534): storing a result of the last iteration.

A bulk preload and poststoretechnique system and method of the present invention applied on a unified advanced VLIW (very long instruction word) DSP (digital-signal processor) provides a file-switching method with better performance. This is achieved by preloading data and switching the preloaded data to the executed cluster and storing the executed result of previous computation. The proposed techniques work well on block-based data computation if no data dependency problems exist between two blocks.

While the present invention has been illustrated with the preferred embodiment, it will be understood by those skilled in the art that the foregoing and other changes in form and details may be made therein without departing from the spirit and scope of the present invention which should be limited only by the scope of the appended claims.

What is claimed is:

1. A bulk preload and poststore technique method applied on a unified advanced VLIW (Very Long Instruction Word) DSP (Digital Signal Processor) comprising:
(1) an iteration of a prolog;
(2) an iteration of a loop body; and
(3) an iteration of a epilog.

2. The bulk preload and poststore technique method applied on the unified advanced VLIW (Very Long Instruction Word) DSP (Digital Signal Processor) of claim 1, wherein step (1) further comprises the following steps:
(11) preloading data into a buffer register file in a second iteration by way of bulk memory access operation in the prolog;
(12) continuing a first iteration.

3. The bulk preload and poststore technique method applied on the unified advanced VLIW (Very Long Instruction Word) DSP (Digital Signal Processor) of claim 1, wherein step (2) further comprises the following steps:
(21) exchanging executed data of preloaded data of a last iteration within the iteration of the loop body;
(22) the executed data in step (21) being stored in terms of postsotring operation;
(23) carrying out a first half operation of the iteration;
(24) preloading the poststored executed data in the step (22) for next operation;
(25) recurring to step (21) and carrying out a second half operation of the iteration.

4. The bulk preload and poststore technique method applied on the unified advanced VLIW (Very Long Instruction Word) DSP (Digital Signal Processor) of claim 1, wherein step (3) further comprises the following steps:
(31) exchanging last executed data in step (2);
(32) storing said executed data;
(33) carrying out a last iteration;
(34) storing a result of the last iteration.

5. A bulk preload and poststore technique system applied on a unified advanced VLIW (Very Long Instruction Word) DSP (Digital Signal Processor), providing a type of register files in an architecture of very long instruction words (VLIW), and said technique system comprising:
a bulk memory access controller having an additional buffer register file, said bulk memory access controller and said additional register file being coupled as an additional cluster, so as to switch data between register file and memory;
a register file switch module connecting clusters to form a switch network; and
a registered file switch controller that controlling said register file switch module, the registered file switch controller switching loaded data among clusters and prestored data after completing bulk memory access operation, and contents among clusters, so as to complete transferring a block of data within one single-cycle.

6. The bulk preload and poststore technique system applied on the unified advanced VLIW (Very Long Instruction Word) DSP (Digital Signal Processor) of claim 5, wherein said bulk memory access controller is in charge of detecting data hazards and avoiding out-of-order executions.

7. The bulk preload and poststore technique system applied on the unified advanced VLIW (Very Long Instruction Word) DSP (Digital Signal Processor) of claim 5, wherein said register file switch module can switches contents between two register files.

8. The bulk preload and poststore technique system applied on the unified advanced VLIW (Very Long Instruction Word) DSP (Digital Signal Processor) of claim 5, wherein said register file switch module, by conducting all read/write operations to substituting register files, can switch target register files of two clusters without having to actually switch data between two register files.

9. The bulk preload and poststore technique system applied on the unified advanced VLIW (Very Long Instruction Word) DSP (Digital Signal Processor) of claim 5, wherein said registered file switch controller determines the target register file of each cluster in said switch network.

10. The bulk preload and poststore technique system applied on the unified advanced VLIW (Very Long Instruction Word) DSP (Digital Signal Processor) of claim 5, wherein said registered file switch controller maintains read/write port direction state of each cluster.

11. The bulk preload and poststore technique system applied on the unified advanced VLIW (Very Long Instruction Word) DSP (Digital Signal Processor) of claim 10, wherein switching state values of two clusters can switch two register files.

12. The bulk preload and poststore technique system applied on the unified advanced VLIW (Very Long Instruction Word) DSP (Digital Signal Processor) of claim 5, wherein said register file switch system further comprises a buffer register file that connects said register file switch module and is applied as a temporal register file for reserving switched data.

13. The bulk preload and poststore technique system applied on the unified advanced VLIW (Very Long Instruction Word) DSP (Digital Signal Processor) of claim 12, wherein said bulk memory access controller loads data from said memory into said buffer register file and stores data from said buffer register file to said memory, and said bulk memory access controller, before using data, preloads this data and stores operated data in said memory.

14. The bulk preload and poststore technique system applied on the unified advanced VLIW (Very Long Instruction Word) DSP (Digital Signal Processor) of claim 13, wherein said bulk memory access controller operates by non-blocking memory access to access data memory, therefore, function unit can proceed register operation without having to wait for completing memory access operation.

15. The bulk preload and poststore technique system applied on the unified advanced VLIW (Very Long Instruction Word) DSP (Digital Signal Processor) of claim 13, wherein said bulk memory access controller maintains a finite state machine, so as to handle these synchronization problems during program operations.

16. The bulk preload and poststore technique system applied on the unified advanced VLIW (Very Long Instruction Word) DSP (Digital Signal Processor) of claim 13, wherein said bulk memory access controller takes an addressing mode of a digital signal processor, so as to speed up memory access operations and decrease instructions for calculating memory addresses.

17. The bulk preload and poststore technique system applied on the unified advanced VLIW (Very Long Instruction Word) DSP (Digital Signal Processor) of claim 5, wherein said registered file switch controller and said bulk memory access controller can be invoked by using a dedicated instruction slot or other function units.

18. The bulk preload and poststore technique system applied on the unified advanced VLIW (Very Long Instruction Word) DSP (Digital Signal Processor) of claim 12, wherein said buffer register file, register file switch module, registered file switch controller, and bulk memory access controller are connected to form said switch network.

19. The bulk preload and poststore technique system applied on the unified advanced VLIW (Very Long Instruction Word) DSP (Digital Signal Processor) of claim 18, wherein register files in said switch network can be switched arbitrarily by programs.
